(19) United States
(12) Patent Application Publication
(10) Pub. No.: US 2024/0347037 A1
(43) Pub. Date: Oct. 17, 2024

(54) METHOD AND APPARATUS FOR SYNTHESIZING UNIFIED VOICE WAVE BASED ON SELF-SUPERVISED LEARNING

(71) Applicant: Supertone Inc., Seoul (KR)

(72) Inventors: Juheon Lee, Seoul (KR); Jinhyeok Yang, Seongnam-si (KR); Hyeong-Seok Choi, Seoul (KR); Hyeongju Kim, Seoul (KR)

(21) Appl. No.: 18/404,568

(22) Filed: Jan. 4, 2024

(30) Foreign Application Priority Data
Apr. 12, 2023 (KR) 10-2023-0047906

(51) Int. Cl. G10L 13/047; G10L 13/033; G10L 25/18

(52) U.S. Cl. CPC G10L 13/047; G10L 13/0335; G10L 25/18

(57) ABSTRACT

Disclosed herein are a self-supervised learning-based unified voice synthesis method and apparatus. The self-supervised learning-based unified voice synthesis method and apparatus: train a voice analysis module to output voice features for training voice signals by using the training voice signals representing training voices, and output voice features for the training voices; and train a voice synthesis module to synthesize voice signals from the voice features for the training voices by using the output voice features, and synthesize synthesized voice signals, representing synthesized voices, from the output voice features. The self-supervised learning-based unified voice synthesis method and apparatus can synthesize voices similar to actual voices by using artificial neural networks that are trained by themselves through self-supervised learning, without the need to train the artificial neural networks on a large quantity of voice and text datasets.

### CROSS-REFERENCE TO RELATED APPLICATION

This application claims priority under 35 U.S.C. § 119 (a) to Korean Patent Application No. 10-2023-0047906 filed in the Korean Intellectual Property Office on Apr. 12, 2023, which is hereby incorporated by reference herein in its entirety.

### BACKGROUND

### 1. Technical Field

The present disclosure relates to a self-supervised learning-based unified voice synthesis method and apparatus, and more particularly to a self-supervised learning-based unified voice synthesis method and apparatus capable of synthesizing voices by using a machine learning model that is trained based on self-supervised learning.

### 2. Description of the Related Art

Text to Speech (TTS) technology refers to a technology that generates arbitrary sentences, input in text form, as human voices, i.e., voice signals, by using a computer. Conventional voice synthesis technologies are classified into a concatenative TTS method that, when generating a voice signal, is used to generate a voice signal for an overall sentence by combining the pre-recorded voice signals of individual syllables and a parametric TTS method that generates voice signals from high-dimensional parameters, in which voice features are represented, by using a vocoder.

Conventional voice synthesis technology generates an overall voice signal for a sentence by combining the voice signals of pre-recorded words, syllables, and phonemes in accordance with input text. Since the voice signal for the sentence generated as described above is generated by synthesizing pre-recorded voice signals, the intonation and prosody of the sentence are not represented in the voice signals, so that there are problems in that the connection between voices is awkward and a sense of heterogeneity from the human voice is felt.

Recently, artificial intelligence (AI) technology has been developing dramatically. Artificial intelligence technology is also being used in a variety of manners in the field of voice synthesis. An artificial intelligence algorithm can use a machine learning algorithm. Machine learning is basically classified into supervised learning and self-supervised learning. Supervised learning trains an artificial intelligence model using the data on which an artificial intelligence-based machine learning model is trained and correct answer labels indicating the types of data. Self-supervised learning trains an artificial intelligence model using only the data, on which an artificial intelligence-based machine learning model is trained, without correct answer labels.

Furthermore, the conventional parametric TTS method has been developed using machine learning to improve the naturalness of voice signals. The conventional parametric TTS method trains artificial neural networks using a large amount of text and voice data, and generates a voice signal for the text of an input sentence using the trained artificial neural networks. Since the machine learning-based parametric TTS method generates a voice signal for input text using artificial neural networks, it is possible to generate a voice signal in which the intonation and prosody of the voice subject of a learned voice signal are represented. Accordingly, the conventional parametric TTS method can generate more natural voice signals than the concatenative TTS method. However, this machine learning-based parametric TTS method has the disadvantage of requiring a large quantity of voice and text datasets to train artificial neural networks.

The above-described disadvantage of the conventional voice synthesis technology also arises in singing voice synthesis (SVS) technology. In this case, the SVS technology is a technology that generates singing voice signals using lyric text and musical score data. Among the conventional voice synthesis technologies, the concatenative TTS method can only generate pre-recorded types of phoneme utterances, and cannot generate singing voice signals in which the pitch, length, beat, etc. of sounds can be freely modified. Accordingly, in the field of singing voice synthesis, the parametric TTS method using artificial neural networks is mainly used.

This artificial neural network-based parametric SST method first trains artificial neural networks on the singing voices of random singers and musical scores and lyric text for corresponding songs. The trained artificial neural networks can generate a singing voice signal, whose timbre and singing style are similar to those of a learned singer's singing voice (i.e., song), based on an input musical score and lyric text.

This problem also arises not only in the parametric TTS method but also in other existing voice or singing voice synthesis methods.

Therefore, in order to overcome these problems, there is an increasing demand for a self-supervised learning-based voice or singing voice synthesis method.

### STATEMENT REGARDING PRIOR DISCLOSURES BY THE INVENTOR OR A JOINT INVENTOR

At least one inventor or joint inventor of the present disclosure has made related disclosures at arXiv: 2211.09407v1 [csSD] submitted on Nov. 17, 2022.

### SUMMARY

An object of the present disclosure is to provide a self-supervised learning-based unified voice synthesis method and apparatus.

Objects of the present disclosure are not limited to the above-described object, and other objects may be derived from the following description.

According to an aspect of the present disclosure, there is provided a self-supervised learning-based voice synthesis method including: training a voice analysis module to output voice features for training voice signals by using the training voice signals representing training voices, and outputting voice features for the training voices; and training a voice synthesis module to synthesize voice signals from the voice features for the training voices by using the output voice features, and synthesizing synthesized voice signals, representing synthesized voices, from the output voice features.

The self-supervised learning-based voice synthesis method may further include calculating the reconstruction loss between the training voice signals and the synthesized voice signals based on the training voice signals and the synthesized voice signals, and training the voice analysis module and the voice synthesis module based on the calculated reconstruction loss.

The voice features of each of the training voices may include the fundamental frequency F₀, periodic amplitude Aₚ[n], aperiodic amplitude Aₐₚ[n], linguistic features, and timbre features of the training voice; and outputting the voice features of the training voices may include: converting each of the training voice signals into probability distribution spectra of a plurality of frequency bins, and outputting a fundamental frequency F₀, periodic amplitude Aₚ[n], and aperiodic amplitude Aₐₚ[n] of the training voice from the probability distribution spectra obtained through the conversion; outputting linguistic features of a text included in the training voice from the training voice signal; and converting the training voice signal into a mel-spectrogram, and outputting timbre features of the training voice from the mel-spectrogram obtained through the conversion.

Synthesizing synthetic voice signals, representing synthetic voices, from the output voice features may include: generating an input excitation signal based on the fundamental frequency F₀, periodic amplitude Aₚ[n], and aperiodic amplitude Aₐₚ[n] of the training voice; generating a time-varying timbre embedding based on the timbre features of the training voice; generating frame-level conditions for the synthesized voice based on the linguistic features of the training voice and the generated time-varying timbre embedding; and synthesizing a synthesized voice signal representing the synthesized voice based on the input excitation signal and the frame-level conditions.

The input excitation signal may be represented by Equation 1 below:

$$z [ t ] = {A}_{p} [ t ] sin ( {\sum }_{k = 1}^{t} 2 π \frac{{F}_{0} [ k ]}{{N}_{s}} ) + {A}_{ap} [ t ] \cdot n [ t ]$$

where Nₛ is sampling rate, and n[t] is sampled noise.

According to another aspect of the present disclosure, there is provided a self-supervised learning-based voice synthesis apparatus including: a voice analysis module configured to be trained to output voice features for training voice signals by using the training voice signals representing training voices, and to output voice features for the training voices; and a voice synthesis module configured to be trained to synthesize voice signals from the voice features for the training voices by using the output voice features, and to synthesize synthesized voice signals, representing synthesized voices, from the output voice features.

According to another aspect of the present disclosure, there is provided a self-supervised learning-based singing voice synthesis method, the self-supervised learning-based singing voice synthesis method being performed by a voice synthesis apparatus, including a voice analysis module configured to be trained to output voice features for training voice signals by using the training voice signals representing training voices, and to output voice features for the training voices, and a voice synthesis module configured to train to synthesize voice signals from the voice features for the training voices by using the output voice features, and to synthesize synthesized voice signals, representing synthesized voices, from the output voice features, the self-supervised learning-based singing voice synthesis method including: obtaining a singing voice synthesis request including a synthesis target song and a synthesis target singer; obtaining a voice signal associated with the synthesis target singer based on the singing voice synthesis request; generating, in a singing voice synthesis (SVS) module, singing voice features including a fundamental frequency F₀, periodic amplitude Aₚ[n], aperiodic amplitude Aₐₚ[n], and linguistic features for the synthesis target song and the synthesis target singer based on the singing voice synthesis request and the voice signal associated with the synthesis target singer; generating, in the voice analysis module, timbre features of the synthesis target singer based on the voice signal associated with the synthesis target singer; and synthesizing, in the voice synthesis module, a singing voice signal, representing a voice in which the synthesis target song is sung using a voice of the synthesis target singer, based on the singing voice features and the timbre features.

The SVS module may be an artificial neural network that is pre-trained to output singing voice features for an input synthesis target song and synthesis target singer by using a training dataset including training songs, training singer voices, and training singing voice features.

According to another aspect of the present disclosure, there is provided a self-supervised learning-based modified voice synthesis method, the self-supervised learning-based modified voice synthesis method being performed by a voice synthesis apparatus, including a voice analysis module configured to be trained to output voice features for training voice signals by using the training voice signals representing training voices, and to output voice features for the training voices, and a voice synthesis module configured to train to synthesize voice signals from the voice features for the training voices by using the output voice features, and to synthesize synthesized voice signals, representing synthesized voices, from the output voice features, the self-supervised learning-based modified voice synthesis method including: obtaining a pre-conversion voice that is a voice conversion target; outputting, in the voice analysis module, pre-conversion voice features including a fundamental frequency F₀, periodic amplitude Aₚ[n], aperiodic amplitude Aₐₚ[n], and linguistic features for the pre-conversion voice based on the obtained pre-conversion voice; obtaining voice attributes for a converted voice; outputting, in a voice design (VOD) module, converted voice features including a fundamental frequency F₀ and timbre features for the converted voice based on the voice attributes for the converted voice; and synthesizing, in the voice synthesis module, the converted voice based on the pre-conversion voice features and the converted voice features.

The VOD module may be an artificial neural network that is pre-trained to output the fundamental frequency F₀ and timbre features of the converted voice based on input voice attributes by using a training dataset including training voice attributes, training basic frequencies F₀, and training timbre features.

According to another aspect of the present disclosure, there is provided a self-supervised learning-based text to speech (TTS) synthesis method, the self-supervised learning-based TTS synthesis method being performed by a voice synthesis apparatus, including a voice analysis module configured to be trained to output voice features for training voice signals by using the training voice signals representing training voices, and to output voice features for the training voices, and a voice synthesis module configured to train to synthesize voice signals from the voice features for the training voices by using the output voice features, and to synthesize synthesized voice signals, representing synthesized voices, from the output voice features, the self-supervised learning-based TTS synthesis method including: obtaining a synthesis target text and a synthesis target voice subject for which TTS synthesis is desired; obtaining a voice associated with the synthesis target voice subject based on the synthesis target voice subject; outputting, in the voice analysis module, voice features of the synthesis target voice subject, including timbre features of the synthesis target voice subject, based on the voice associated with the synthesis target voice subject; outputting, in a TTS module, voice features of a text voice, including a fundamental frequency F₀, periodic amplitude Aₚ[n], and aperiodic amplitude Aₐₚ[n] for the text voice in which the synthesis target text is read using a voice of the synthesis target voice subject, based on the synthesis target text and the voice associated with the synthesis target voice subject; and synthesizing the text voice based on the fundamental frequency F₀, periodic amplitude Aₚ[n], and aperiodic amplitude Aₐₚ[n] for the text voice and the timbre features of the synthesis target voice subject.

The TTS module may be an artificial neural network that is pre-trained to output the fundamental frequency F₀, periodic amplitude Aₚ[n], and aperiodic amplitude Aₐₚ[n] of the text voice based on an input text and voice by using a training dataset including training synthesized texts, training voices, and training voice features.

According to still another aspect of the present disclosure, there is provided a non-transitory computer-readable storage medium having stored thereon a program that, when executed by a processor, causes the processor to execute any one of the methods according to the first aspect.

The voice synthesis apparatus and method according to the present disclosure analyze voice signals using self-supervised learning-based artificial intelligence, extract the voice features of the voice signals, and synthesize voices again based on the extracted voice features. The artificial intelligence outputs the voice features of input voices while repeating the analysis and synthesis of voice signals, and synthesizes voices again based on the output voice features. According to the embodiments of the present disclosure, the artificial neural networks are trained to extract the voice features of input voices by themselves, and are also trained to output synthesized voices based on the extracted voice features. The self-supervised learning-based artificial intelligence model is employed, so that there is no need for a large amount of training audio data required to train an artificial neural network model compared to a supervised learning-based artificial intelligence model in the field of voice synthesis, and so that the artificial neural networks for voice synthesis can be trained rapidly and easily.

Furthermore, the voice analysis module and the voice synthesis module, which are artificial neural networks of the voice synthesis apparatus, calculate the reconstruction loss between input voices and synthesized voices during self-supervised learning and are trained based on the calculated reconstruction loss, so that the differences between the voices synthesized by the voice synthesis apparatus and actual voices are minimized. Accordingly, the voice synthesis apparatus may synthesize voices, which are more natural and considerably similar to actual voices, by using a loss function.

The voice synthesis method may convert an arbitrary singing voice into the voice of a singer desired by a user by utilizing the artificial neural networks that are trained by a self-supervised learning method. Accordingly, it may be possible to synthesize a singing voice that is not actually sung by a synthesis target singer but is identical or considerably similar and natural as if it were actually sung by the synthesis target singer.

Furthermore, the voice synthesis method may train the artificial neural networks capable of analyzing voices using only a predetermined quantity of training voices and synthesizing voices based on the results of the analysis. For example, the artificial neural networks for voice synthesis may be trained using a small quantity of voices corresponding to about 10 minutes. Accordingly, the voice of the deceased may be restored using only a small quantity of data in which the voice of a famous singer or great person who passed away was recorded while he or she was alive without a large quantity of voice data or voice data over a long period of time.

### BRIEF DESCRIPTION OF THE DRAWINGS

The above and other objects, features, and advantages of the present disclosure will be more clearly understood from the following detailed description taken in conjunction with the accompanying drawings.

FIG. 1 is a diagram showing the configuration of a voice synthesis apparatus according to an embodiment of the present disclosure.

FIG. 2 is a diagram showing an example of the process of training a voice analysis module and a voice synthesis module in the voice synthesis apparatus shown in FIG. 1.

FIG. 3 is a diagram showing the detailed architecture of a pitch encoder according to an embodiment of the present disclosure.

FIG. 4 is a diagram showing the detailed architecture of a linguistic encoder according to an embodiment of the present disclosure.

FIG. 5 is a diagram showing the detailed architecture of a timbre encoder according to an embodiment of the present disclosure.

FIG. 6 is a diagram showing the detailed architecture of a frame-level synthesis neural network according to an embodiment of the present disclosure.

FIG. 7 is a diagram showing the detailed architecture of a time-varying timbre neural network according to an embodiment of the present disclosure.

FIG. 8 is a flowchart of a self-supervised learning-based voice synthesis method according to an embodiment of the present disclosure according to an embodiment of the present disclosure.

FIG. 9 is a flowchart of a self-supervised learning-based singing voice synthesis method according to an embodiment of the present disclosure according to an embodiment of the present disclosure.

FIG. 10 is a flowchart of a self-supervised learning-based modified voice synthesis method according to another embodiment of the present disclosure according to an embodiment of the present disclosure.

FIG. 11 is a flowchart of a self-supervised learning-based TTS synthesis method according to another embodiment of the present disclosure.

### DETAILED DESCRIPTION

The advantages and features of the present disclosure and methods for achieving them will become clear by referring to embodiments to be described in detail below in conjunction with the accompanying drawings. However, the technical spirit of the present disclosure is not limited to the following embodiments and may be implemented in various different forms. The following embodiments are provided merely to complete the present disclosure of the technical spirit and to fully inform those of ordinary skill in the art to which the present disclosure pertains of the scope of the present disclosure. The technical spirit of the present disclosure is only defined by the scope of the claims.

When reference numerals are assigned to components in the individual drawings, it should be noted that like components are given like reference numerals as much as possible even when they are illustrated in different drawings. Additionally, in the following description of the present disclosure, when it is determined that a detailed description of a related known component or function may obscure the gist of the present disclosure, the detailed description will be omitted.

Unless otherwise defined, all the terms (including technical and scientific terms) used herein may be used to have meanings that can be understood in common by those of ordinary skill in the art to which this disclosure pertains. Additionally, the terms defined in commonly used dictionaries are not interpreted ideally or excessively unless clearly specifically defined. The terms used herein are intended to describe embodiments, and are not intended to limit the present disclosure. As used herein, singular forms also include plural forms, unless specifically stated otherwise in the context.

Furthermore, in the description of the components of the present disclosure, the terms such as first, second, A, B, (a), (b), etc. may be used. These terms are each used merely to distinguish a corresponding component from other components, and the nature, sequence, or order of the component is not limited by the term. When a component is described as being “connected,” “coupled,” or “linked” to another component, it should be understood that the former component may be directly connected, coupled, or linked to the other component but the two components may be “connected,” “coupled,” or “linked” to each other with a third component disposed therebetween.

The terms “include or comprise” and/or “including or comprising” used herein do not exclude the presence or addition of one or more other components, steps, operations, and/or elements other than or to one or more mentioned components, steps, operations, and/or elements.

The following terms used in the detailed description of embodiments of the present disclosure below have the following meanings. The term “voice” refers to a human voice, which is the sound produced via the human vocal organ, and includes not only human speech but also a singing voice, which is a song represented in a human voice. The term “sound” is a type of waves that are transmitted due to vibrations generated when the vocal cords of the larynx in the throat vibrate. The term “voice signal” refers to a signal representing the voice of a voice subject.

The term “voice subject” refers to a speaker who uttered a corresponding voice. The term “timbre” is a voice characteristic unique to a voice subject that is physically determined by the structure of the vocal organ of the human body, and has distinctive features based on the harmonic structure of voice for each voice subject.

A component included in any one embodiment and having the same function may be described using the same name in another embodiment. Unless stated to the contrary, a description given in any one embodiment may be applied to another embodiment. A detailed description may be omitted to the extent that it overlaps another description or can be clearly understood by those of ordinary skill in the art to which the present disclosure pertains.

Some embodiments of the present disclosure will be described in detail below with reference to the accompanying drawings.

The present disclosure may be modified in various manners and have various embodiments. Specific embodiments are illustrated in the drawings and described in detail in the detailed description. However, this is not intended to limit the present disclosure to the specific embodiments, and should be understood as encompassing all modifications, equivalents, and substitutes included in the technical spirit and scope of the present disclosure.

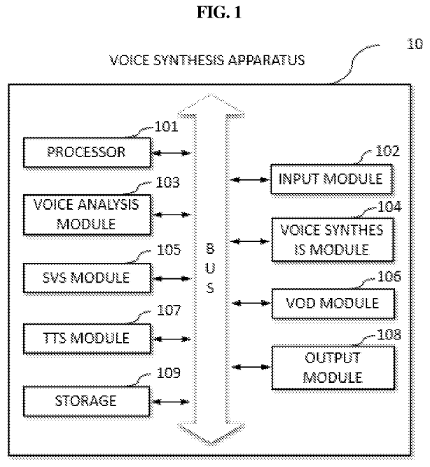

FIG. 1 is a diagram showing the configuration of a voice synthesis apparatus 10 according to an embodiment of the present disclosure. Referring to FIG. 1, the voice synthesis apparatus 10 includes a processor 101, an input module 102, a voice analysis module 103, a voice synthesis module 104, a singing voice synthesis (SVS) module 105, a voice design (VOD) module 106, a text-to-speech (TTS) module 107, an output module 108, and storage 109.

The processor 101 of the voice synthesis apparatus 10 processes the general tasks of the voice synthesis apparatus 10.

The input module 102 of the voice synthesis apparatus 10 obtains a voice synthesis request for a synthesis target voice to be synthesized and training data for the training of artificial neural networks included in the voice synthesis apparatus 10 from a user. The input module 102 receives voice attributes, a musical score, the text of synthesized voice data, a synthesis target voice, a synthesis target singer, and/or the like for a converted voice that the user wants from the user. In this case, the voice attributes include the gender, age, pitch and/or the like of a voice subject. Examples of the input module 102 include a keyboard, a mouse, a touch panel, and the like.

The voice analysis module 103 of the voice synthesis apparatus 10 outputs features of an input voice. The voice analysis module 103 outputs features of a voice input through the input module 102. More specifically, the voice analysis module 103 outputs the fundamental frequency F₀, periodic amplitude Aₚ[n], aperiodic amplitude Aₐₚ[n], linguistic features, and timbre features of the input voice. In this case, the voice analysis module 103 analyzes the voice based on self-supervised learning. The process of outputting the features of the input voice in the voice analysis module 103 will be described in detail below. The voice analysis module 103 inputs the output fundamental frequency F₀, the periodic amplitude Aₚ[n], the aperiodic amplitude Aₐₚ[n], the linguistic feature, and the timbre features to the voice synthesis module 104.

The voice synthesis module 104 of the voice synthesis apparatus 10 synthesizes a voice based on the inputs received from the voice analysis module 103. More specifically, the voice synthesis module 104 synthesizes a voice signal based on the fundamental frequency F₀, the periodic amplitude Aₚ[n], the aperiodic amplitude Aₐₚ[n], the linguistic feature, and the timbre feature input from the voice analysis module 103. The process of synthesizing a voice signal based on the voice features input from the voice synthesis module 104 will be described in detail below.

The SVS module 105 of the voice synthesis apparatus 10 is a module that is set to output the features of a singing voice in order to synthesize a singing voice signal. The SVS module 105 outputs singing voice features based on an input synthesis target song and a voice of a synthesis target singer. More specifically, the SVS module 105 analyzes the input song and the voice of the singer and outputs the output fundamental frequency F₀, periodic amplitude Aₚ[n], aperiodic amplitude Aₐₚ[n], and linguistic feature of the input song and singer. In this case, the synthesis target song includes a musical score and lyrics for the song. The singing voice features output from the SVS module 105 are voice features for the voice in which the synthesis target song, input in the input voice of the singer, is sung.

In this case, the SVS module 105 is an artificial neural network that is trained in advance to output the singing voice features of the input song and singer from the input song and voice of the singer. The SVS module 105 is an artificial neural network that is pre-trained on a training dataset including training songs, training singer voices, and training singing voice features.

The SVS module 105 inputs the output fundamental frequency F₀, periodic amplitude Aₚ[n], aperiodic amplitude Aₐₚ[n], and linguistic feature to the voice synthesis module 104. The voice synthesis module 104 synthesizes the voice, in which the musical score input in the input singing voice of the singer is sung, based on the singing voice features input from the SVS module 105 and the timbre feature input from the voice analysis module 103.

The VOD module 106 of the voice synthesis apparatus 10 is a module that is set to output the features of a converted voice in order to convert an arbitrary voice into a voice having a desired characteristic. The VOD module 106 outputs the features of the converted voice based on the voice attributes of the converted voice input by the user. More specifically, the VOD module 106 outputs the fundamental frequency F₀ and timbre feature of the converted voice input from the input module 102. In this case, the converted voice refers to a voice in which the voice features, such as voice, tone, timbre, pitch, and/or the like, of an original voice are converted. A voice attribute for the converted voice is a command input from the user through the input module 102.

The voice attributes of the converted voice are conversion target voice attributes selected from the fundamental features of a voice, and include the gender of the voice subject, the age of the voice subject, and the pitch of the voice. For example, when the user wants to convert a current male voice whose voice subject is a male into a female voice whose voice subject is a female, the user inputs the gender of the voice subject as female when entering a voice attribute for the converted voice. The user inputs the one or more voice attributes of the converted voice through the input module 102 in accordance with the one or more characteristics of the voice subject that the user wants to convert. The user may input gender and age, which are voice attributes of a current voice that the user wants to convert, into the input module 102.

The VOD module 106 is an artificial neural network that is pre-trained to output the features of a converted voice from the input voice attributes of the converted voice. The VOD module 106 is an artificial neural network that is pre-trained on a training dataset including training voice signals, the attributes of training converted voices, the fundamental frequencies F₀ of the training converted voices, and the timbre features of the training converted voices.

According to another embodiment of the present disclosure, the VOD module 106 is an artificial neural network that is pre-trained to output the fundamental frequency F₀ and timbre features of a converted voice based on the voice attributes of a pre-conversion voice and the converted voice.

The VOD module 106 inputs the fundamental frequency F₀ and the timbre features, which are features of the output converted voice, to the voice synthesis module 104. The voice synthesis module 104 synthesizes the converted voice having one or more converted features input by the user based on the fundamental frequency F₀ and timbre features input from the VOD module 106, and the periodic amplitude Aₚ[n], non-periodic amplitude Aₐₚ[n] and linguistic features input from the voice analysis module 103.

The TTS module 107 of the voice synthesis apparatus 10 is a module that is set to output the features of an input text in order to convert the text into a voice. The TTS module 107 outputs speech voice features based on an input text and voice subject (speaker). More specifically, the TTS module 107 analyzes the input text and the voice of the input voice subject, and outputs the speech voice features of the input text and voice subject. The TTS module 107 outputs the fundamental frequency F₀, periodic amplitude Aₚ[n], aperiodic amplitude Aₐₚ[n], and linguistic features of the input text and voice subject.

In this case, the TTS module 107 is an artificial neural network that is pre-trained to output speech voice features of the input text and voice subject from the input text and voice of the voice subject. The TTS module 107 is an artificial neural network that is pre-trained on a training dataset including training texts, training voice subject voices, and training voice features.

The output module 108 of the voice synthesis apparatus 10 converts a voice into an auditory signal that the user can hear, and outputs the auditory signal. The output module 108 converts the voice synthesized in the voice synthesis module 104 into an auditory signal, and outputs it. An example of the output module 108 may be a speaker.

The storage 109 of the voice synthesis apparatus 10 stores data necessary for voice synthesis. For example, the storage 109 stores a training voice dataset for the training of artificial neural networks constituting part of the voice synthesis apparatus 10. In this case, the training voice dataset includes not only voice data representing speeches but also singing voice data representing singing voices.

In the voice synthesis apparatus 10 according to embodiments of the present disclosure, the input module 102, the voice analysis module 103, and the voice synthesis module 104 may be implemented by a dedicated processor separate from the processor 101. Alternatively, they may also be implemented through the execution of a computer program executed by the processor 101.

The voice synthesis apparatus 10 may further include one or more additional components in addition to the components described above. For example, as shown in FIG. 1, the voice synthesis apparatus 10 includes a bus for the transmission of data between various components. Furthermore, although omitted in FIG. 1, the voice synthesis apparatus 10 may further include components such as a power unit configured to supply driving power to the individual components, a training unit configured to train artificial neural networks, and a communication module configured to exchange data and signals with an external terminal. As described above, detailed descriptions of components that are obvious to those of ordinary skill in the art to which the present disclosure pertains will be omitted because they may obscure the features of the present embodiment. Hereinafter, in the process of describing a voice synthesis method according to an embodiment of the present disclosure, the individual components of the voice synthesis apparatus 10 will be described in detail.

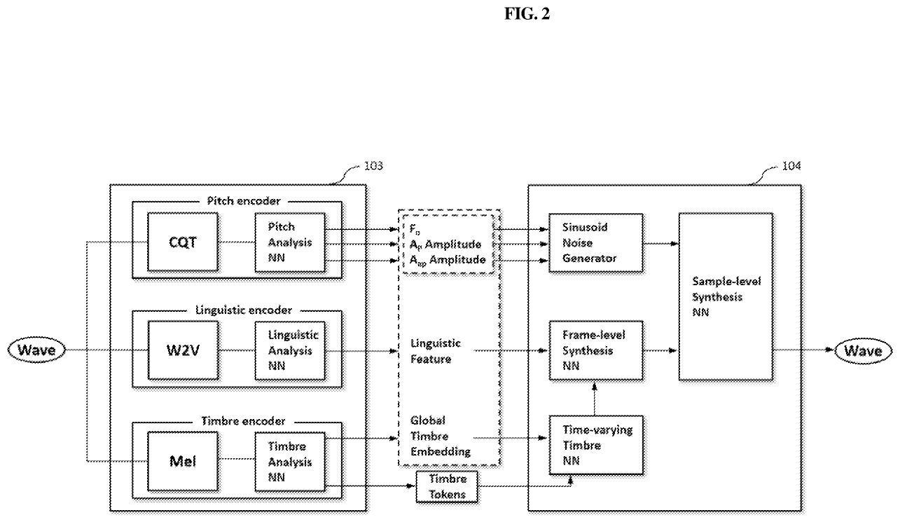

FIG. 2 is a diagram showing an example of the process of training a voice analysis module and a voice synthesis module in the voice synthesis apparatus shown in FIG. 1. Referring to FIG. 2, the voice analysis module 103 of the voice synthesis apparatus 10 includes a pitch encoder, a linguistic encoder, and a timbre encoder. The voice synthesis module 104 of the voice synthesis apparatus 10 includes a sinusoid noise generator, a frame-level synthesis neural network, a time-varying timbre neural network, and a sample-level synthesis neural network.

A voice input to the voice analysis module 103 of the voice synthesis apparatus 10 is input to the pitch encoder, the linguistic encoder, and the timbre encoder.

The pitch encoder is an encoder that analyzes the pitch of a voice. The pitch encoder outputs the fundamental frequency F₀, periodic amplitude Aₚ[n], and aperiodic amplitude Aₐₚ[n] of an input voice based on the voice input to the voice analysis module 103. The pitch refers to the pitch of a sound, and the pitch of a sound is determined by the frequency of the sound. A high-pitched sound has a high frequency, and a low-pitched sound has a low frequency.

The pitch encoder includes a constant-Q transform (CQT) and a pitch analysis neural network. The CQT generates a pitch (i.e., a musical scale) falling at a predetermined rate as the spectra of a specific frequency band. The CQT separates the spectra into 64 frequency bins in the range of 50 Hz to 1,000 Hz, and outputs the probability distribution of each frequency bin. The CQT inputs the output probability distribution spectra of the frequency bins into the pitch analysis neural network.

The pitch analysis neural network analyzes the probability distribution spectra of the frequency bins input from the CQT and outputs the fundamental frequency F₀, periodic amplitude Aₚ[n], and aperiodic amplitude Aₐₚ[n] of a voice input to the pitch encoder. The pitch analysis neural network is an artificial neural network model that analyzes the probability distribution spectra of the frequency bins based on self-supervised learning and outputs the fundamental frequency F₀, periodic amplitude Aₚ[n], and aperiodic amplitude Aₐₚ[n] of the input voice.

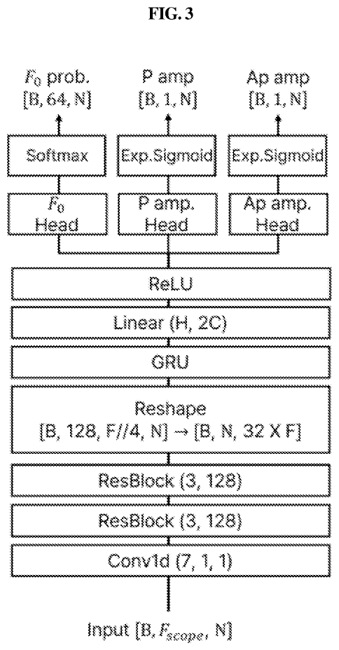

In connection with this, FIG. 3 is a diagram showing the detailed architecture of a pitch encoder. More specifically, FIG. 3 shows the neural architecture of the pitch encoder. Referring to FIG. 3, the pitch analysis neural network of the pitch encoder includes nine layers. The pitch encoder includes Convld, ResBlock, Reshape, GRU, Linear, ReLU, F₀ Head, Pamp Head, Ap amp Head, Softmax, and Exp.Sigmoid layers.

Descriptions of the respective layers will be omitted to prevent the features of the present disclosure from being obscured.

The linguistic encoder analyzes the linguistic features of a text included in a voice. The linguistic encoder outputs the linguistic features of an input voice based on the voice input to the voice analysis module 103. The linguistic encoder extracts the feature vectors of phonetic symbols representing the text included in the input voice.

The linguistic encoder includes wav2vec (waveform to vector) and a linguistic analysis neural network. The wav2vec recognizes an input voice and converts it into a text in a symbolic sequence form. The wav2vec inputs the text, obtained through the conversion, into the linguistic analysis neural network. The wav2vec is an artificial neural network model that recognizes the text from the voice based on self-supervised learning.

The linguistic analysis neural network analyzes the text input from wav2vec and outputs the linguistic features of the text included in the voice. The linguistic analysis neural network is an artificial neural network model that analyzes the input text based on self-supervised learning and outputs the linguistic features of the text.

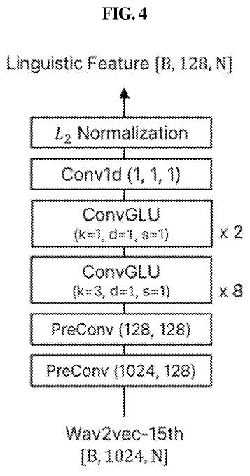

In connection with this, FIG. 4 is a diagram showing the detailed architecture of a linguistic encoder. More specifically, FIG. 4 shows the neural architecture of the feature encoder. Referring to FIG. 4, the linguistic encoder includes six layers. The linguistic encoder includes two PreConv, two ConvGLU, Convld, and L2 normalization layers.

Descriptions of the respective layers will be omitted to prevent the features of the present disclosure from being obscured.

The timbre encoder analyzes timbre features, which are the unique timbres of a voice subject included in a voice. The timbre encoder outputs the timbre features of an input voice based on the voice input to the voice analysis module 103.

The timbre encoder includes a mel-spectrogram conversion unit and a timbre analysis neural network. The mel-spectrogram conversion unit converts an input voice into a mel-spectrogram. The mel-spectrogram conversion unit inputs the voice, converted into a mel-scale, to the timbre analysis neural network.

The timbre analysis neural network analyzes the voice input from the mel-spectrogram conversion unit and outputs the timbre features of a voice subject who uttered the voice. The timbre analysis neural network is an artificial neural network model that analyzes the input mel-scale voice based on self-supervised learning and outputs the timbre features of the voice.

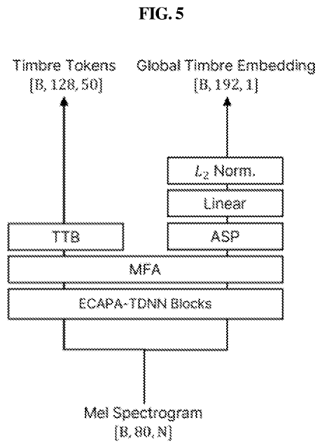

In connection with this, FIG. 5 is a diagram showing the detailed architecture of a timbre encoder. More specifically, FIG. 5 shows the neural architecture of the timbre encoder. Referring to FIG. 5, the timbre encoder includes five layers. The timbre encoder includes ECAPA-TDNN Blocks, Multilayer Feature Aggregation (MFA), Timber Token Block (TTB), Attentive Statistical Pooling (ASP), Linear, and L2 Normalization layers. The timbre features output by the timbre encoder include a global timbre embedding and timbre tokens. The global timbre embedding represents the timbre information of an overall voice in a vector form. A timbre token is a basic unit representing a voice waveform, and represents a timbre feature corresponding to each phoneme in a voice and is represented in a vector form.

Descriptions of the respective layers will be omitted to prevent the features of the present disclosure from being obscured.

The voice synthesis module 104 includes a sinusoid noise generator, a frame-level synthesis neural network, a time-varying timbre neural network, and a sample-level synthesis neural network.

The sinusoid noise generator generates sine waves and noise. The sinusoid noise generator generates sine waves based on the voice features output by the voice analysis module 103. More specifically, the sinusoid noise generator generates sine waves and noise based on the fundamental frequency F₀, the periodic amplitude Aₚ[n], and the aperiodic amplitude Aₐₚ[n]. The sine waves and noise generated by the sinusoid noise generator are represented by Equations 1 and 2, respectively.

$$x [ t ] = {A}_{p} [ r ] sin ( {\sum }_{k = 1}^{t} 2 π \frac{{F}_{0} [ k ]}{{N}_{s}} ) \qquad ( 1 )$$

$$y [ t ] = {A}_{ap} [ t ] \cdot n [ t ] \qquad ( 2 )$$

In these equations, Nₛ is the sampling rate, Aₚ[t] is a value obtained by up-sampling Aₚ[n] at the frame-level to the sample level, and Aₐₚ[t] is a value obtained by up-sampling Aₐₚ[n] at the frame-level to the sample level. n[t] is a sampled noise value, and more specifically, noise extracted by uniformly performing sampling between −1 and 1.

The sinusoid noise generator generates an input excitation signal z[t]=x[t]+y[t] for the voice synthesis module 104 by adding the generated sine waves and noise together. The sinusoid noise generator inputs the generated input excitation signal z[t] to the sample-level synthesis neural network.

The frame-level synthesis neural network generates frame-level conditions for a sample-level synthesizer based on the linguistic features input from the voice analysis module 103 and the time-varying timbre embedding input from the time-varying timbre neural network. The frame-level conditions represent detailed features such as timbre, pronunciation, and emotion in each frame of a voice.

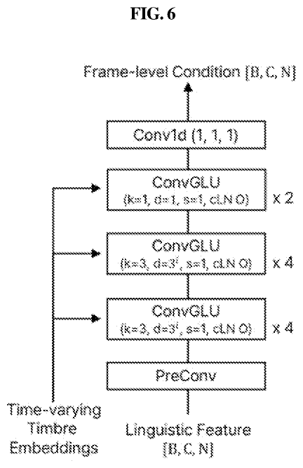

In connection with this, FIG. 6 is a diagram showing the detailed architecture of a frame-level synthesis neural network. More specifically, FIG. 6 shows the neural architecture of the frame-level synthesis neural network. Referring to FIG. 6, the frame-level synthesis neural network includes PreConv, multiple ConvGLU, and Convld layers. The frame-level synthesis neural network is a self-supervised learning-based neural network, and outputs frame-level conditions through the processing of input values between the layers described above.

The frame-level synthesis neural network inputs the generated frame-level conditions to the sample-level synthesis neural network.

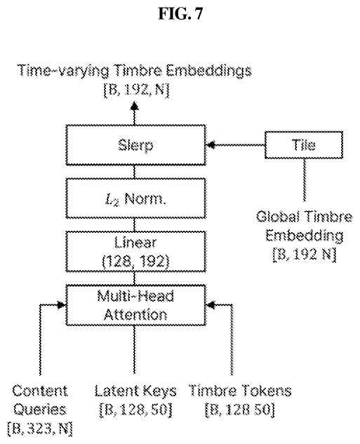

The time-varying timbre neural network generates a time-varying timbre embedding based on the timbre features input from the voice analysis module 103. The time-varying timbre embedding represents the timbre in a vector form for each time step of a voice. In connection with this, FIG. 7 is a diagram showing the detailed architecture of a time-varying timbre neural network. More specifically, FIG. 7 shows the neural architecture of the time-varying timbre neural network. Referring to FIG. 7, the time-varying timbre neural network includes Multi-Head Attention, Linear, L2 Normalization, Slerp, and Tile layers. The time-varying timbre neural network is a self-supervised learning-based neural network, and outputs a time-varying timbre embedding through the processing of input values between the layers described above.

The time-varying timbre neural network inputs the generated time-varying timbre embedding to the frame-level synthesis neural network.

The sample-level synthesis neural network synthesizes a voice based on sine waves, noise, and frame-level conditions. The sample-level synthesis neural network according to an embodiment of the present disclosure is based on a parallel wave generative adversarial network (PWGAN) model. The sample-level synthesis neural network is a self-supervised learning-based neural network, and synthesizes a voice through the processing of input values between the layers described above and outputs the voice.

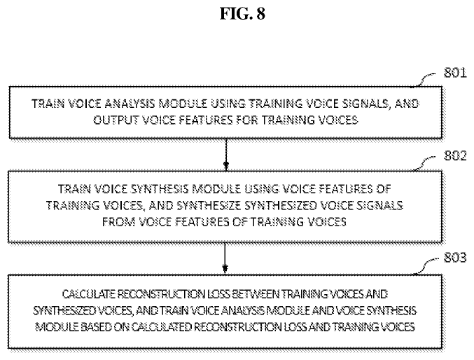

FIG. 8 is a flowchart of a self-supervised learning-based voice synthesis method according to an embodiment of the present disclosure. It is assumed that, among the artificial neural networks of the voice synthesis apparatus 10 that performs the self-supervised learning-based voice synthesis method shown in FIG. 8, the SVS module 105, the VOD module 106, and the TTS module 107, which are supervised learning models, are each trained in advance on a training dataset before performing the voice synthesis method according to the present embodiment of the present disclosure.

Referring to FIG. 8, in step 801, the voice synthesis apparatus 10 trains the voice analysis module 103 of the voice synthesis apparatus 10 to output voice features for training voices by using training voice signals representing the training voices, and outputs the voice features for the training voices. More specifically, the processor 101 of the voice synthesis apparatus 10 inputs the training voice signals, stored in the storage 109, to the voice analysis module 103. The voice analysis module 103 is trained to output the voice features for the training voices that are represented by the input training voice signals. The voice synthesis apparatus 10 trains the voice analysis module 103 through self-supervised learning. Each of the training voice signals is a signal representing a voice that is recorded by an arbitrary voice subject. The training voice signal is not limited to an arbitrary signal, and a recorded human voice may be used for training.

The processor 101 of the voice synthesis apparatus 10 inputs the training voice signals, stored in the storage 109, to the voice analysis module 103. The voice synthesis apparatus 10 inputs the training voices to the voice analysis module 103 in order to train the voice analysis module 103 to output the voice features represented by the input training voice signals. The voice analysis module 103 includes a plurality of encoders. The voice analysis module 103 performs self-supervised learning to output the voice features from the input training voices.

More specifically, the voice analysis module 103 outputs the fundamental frequency F₀, periodic amplitude Aₚ[n], aperiodic amplitude Aₐₚ[n], linguistic features, and timbre features of each of the input learning voices. The voice analysis module 103 inputs each of the input training voice signals to the pitch encoder, the linguistic encoder, and the timbre encoder.

The pitch encoder outputs the pitch features of the input training voice. The pitch encoder includes a CQT configured to convert a voice into the probability distribution spectra of frequency bins and a pitch analysis neural network configured to output the pitch features of a voice. The pitch analysis neural network is a self-supervised learning-based neural network.

The CQT of the pitch encoder converts the input training voice into the probability distribution spectrum of each frequency bin through the CQT, and the pitch analysis neural network generates the fundamental frequency F₀, periodic amplitude Aₚ[n] and the aperiodic amplitude Aₐₚ[n] of the training voice based on the probability distribution spectrum of each frequency bin and outputs them.

The linguistic encoder outputs the linguistic features of a text, included in a voice represented by the training voice signal, from the input training voice signal. The linguistic encoder analyzes the training voice signal using an artificial neural network, and outputs the feature vectors of phonetic symbols representing the text included in the training voice. The linguistic encoder according to an embodiment of the present disclosure converts the training voice, included in the input training voice signal, into a symbolic sequence, converts the symbolic sequence into the linguistic features of the training voice, and outputs them.

The linguistic encoder according to another embodiment of the present disclosure recognizes and extracts a text included in an input training voice signal, and generates and outputs the linguistic features of the extracted text. The linguistic encoder includes wav2vec configured to recognize a text from a voice signal, and a linguistic analysis neural network configured to output linguistic features from the text. The linguistic analysis neural network is a self-supervised learning-based neural network. The wav2vec of the linguistic encoder converts the input learning voice into a symbolic sequence, and the linguistic analysis neural network converts the symbolic sequence into the linguistic features of the training voice and outputs them.

The timbre encoder outputs the timbre features of the voice subject of the input training voice. The timbre encoder converts the input training voice into a mel-spectrogram, analyzes the mel-spectrogram obtained through the conversion, and outputs timbre features. The timbre encoder includes a mel-spectrogram conversion unit configured to convert an input voice into a mel-spectrogram, and a timbre analysis neural network configured to output timbre features from the mel-spectrogram. The timbre analysis neural network is a self-supervised learning-based neural network.

The timbre encoder converts a voice in a wave form into a mel-spectrogram and inputs the mel-spectrogram into the timbre analysis neural network. The timbre analysis neural network converts the input mel-spectrogram into timbre features through each layer and outputs them.

The voice analysis module 103 inputs the voice features of the training voice, including the fundamental frequency F₀, the periodic amplitude Aₚ[n], the aperiodic amplitude Aₐₚ[n], the linguistic features, and the timbre features output from each encoder, to the voice synthesis module 104.

In step 802, the voice synthesis apparatus 10 trains the voice synthesis module 104 to synthesize voice signals from the voice features of the training voices by using the voice features of the training voices, and synthesizes synthesized voice signals from the voice features of the training voices. More specifically, the voice synthesis module 104 of the voice synthesis apparatus 10 trains the voice synthesis module 104 to synthesize synthesized voice signals by using the voice features of the training voices input from the voice analysis module 103. The voice synthesis apparatus 10 trains the voice synthesis module 104 through self-supervised learning. In this case, the synthesized voice signals are signals representing synthesized voices that are generated by the voice synthesis module 104.

The voice synthesis module 104 synthesizes a voice based on the fundamental frequency F₀, the periodic amplitude Aₚ[n], the aperiodic amplitude Aₐₚ[n], the linguistic features, and the timbre features input from the voice analysis module 103.

More specifically, the voice analysis module 103 inputs the fundamental frequency F₀, the periodic amplitude Aₚ[n], and the aperiodic amplitude Aₐₚ[n] to the sinusoid noise generator, inputs the linguistic features to the frame-level synthesis neural network, and inputs the timbre features to the time-varying timbre neural network.

The sinusoid noise generator is trained to generate sine waves and noise based on the fundamental frequency F₀, the periodic amplitude Aₚ[n], and the aperiodic amplitude Aₐₚ[n] input from the voice analysis module 103. In this case, the sinusoid noise generator is a self-supervised learning-based artificial neural network model. The sinusoid noise generator generates sine waves and noise according to the equations described in Equations 1 and 2 described above. The sinusoid noise generator inputs an input excitation signal z[t], obtained by adding the generated sine waves and noise, to the sample-level synthesis neural network.

The time-varying timbre neural network is trained to generate a time-varying timbre embedding based on the timbre features input from the voice analysis module 103. In this case, the time-varying timbre neural network is a self-supervised learning-based artificial neural network model. The time-varying timbre neural network generates timbre features, including a global timbre embedding and timbre tokens, as a time-varying timbre embedding based on a plurality of layers. The time-varying timbre neural network inputs the generated time-varying timbre embedding into the frame-level synthesis neural network.

The frame-level synthesis neural network is trained to generate frame-level conditions based on the linguistic features input from the voice analysis module 103 and the time-varying timbre embedding input from the time-varying timbre neural network. In this case, the frame-level synthetic neural network is a self-supervised learning-based artificial neural network model. The frame-level synthesis neural network generates the linguistic features and the time-varying timbre embedding as frame-level conditions based on a plurality of layers. The frame-level synthesis neural network inputs the generated frame-level conditions to the sample-level synthesis neural network.

The sample-level synthesis neural network is trained to synthesize voice signals from input excitation signals and frame level conditions. In this case, the sample-level synthetic neural network is a self-supervised learning-based artificial neural network model. The sample-level synthesis neural network synthesizes synthesized voice signals based on the input excitation signals and frame-level conditions.

In step 803, the voice synthesis apparatus 10 calculates the reconstruction loss between the input training voices and the synthesized voices, and trains the voice analysis module 103 and the voice synthesis module 104 on the calculated reconstruction loss and the training voices. The processor 101 of the voice synthesis apparatus 10 calculates the reconstruction loss between input training voices and output voices. The reconstruction loss includes multi-scale spectrogram (MSS) loss, mel-spectrogram loss, adversarial loss, and feature matching loss. The MSS loss uses a linear frequency scale spectrogram rather than a log scale spectrogram.

The voice synthesis apparatus 10 according to another embodiment of the present disclosure may calculate the differences between input training voices and output synthesized voices by using one of loss functions such as Kullback-Leibler divergence loss (KLD), Mean Squared Error (MSE), Root Mean Squared Error (RMSE), and binary crossentropy, other than reconstruction loss.

The processor 101 inputs the calculated reconstruction loss and the training voices to the voice analysis module 103. The voice analysis module 103 and the voice synthesis module 104 are trained based on the input reconstruction loss and training voices.

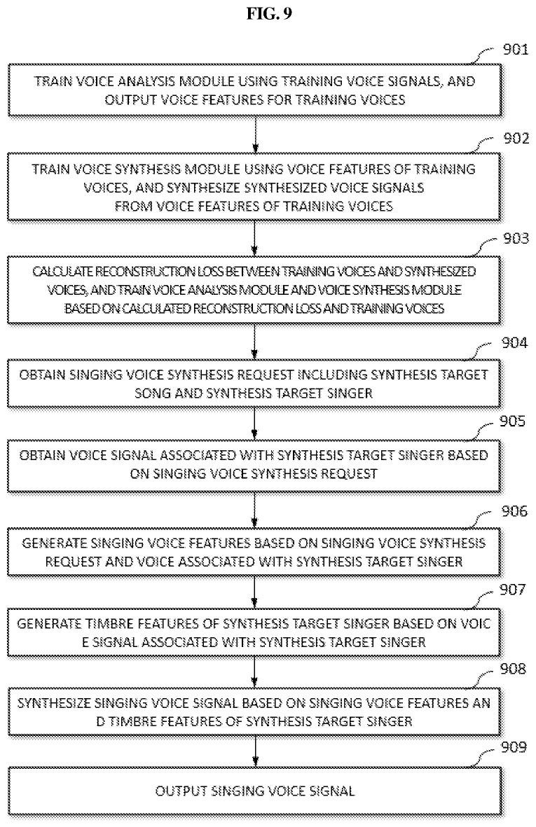

FIG. 9 is a flowchart of a self-supervised learning-based singing voice synthesis method according to an embodiment of the present disclosure. It is assumed that, among the artificial neural networks of the voice synthesis apparatus 10 that performs the self-supervised learning-based singing voice synthesis method shown in FIG. 9, the SVS module 105, the VOD module 106, and the TTS module 107, which are supervised learning models, are each trained in advance on a training dataset before performing the singing voice synthesis method according to the present embodiment of the present disclosure.

Referring to FIG. 9, in step 901, the voice synthesis apparatus 10 trains the voice analysis module 103 of the voice synthesis apparatus 10 to output the voice features of training voices by using training voice signals representing the training voices, and outputs the voice features of training voices. The voice synthesis apparatus 10 trains the voice analysis module 103 through self-supervised learning. Detailed descriptions of the operation and learning method of the voice analysis module 103 in step 901 will be replaced with the descriptions given in conjunction with step 801.

In step 902, the voice synthesis apparatus 10 trains the voice synthesis module 104 to synthesize voice signals from the voice features of the training voices by using the voice features of the training voices, and synthesizes synthesized voice signals from the voice features of the training voices. The voice synthesis apparatus 10 trains the voice synthesis module 104 through self-supervised learning. Detailed descriptions of the operation and learning method of the voice synthesis module 104 in step 902 will be replaced with the descriptions given in conjunction with step 802.

In step 903, the voice synthesis apparatus 10 calculates the reconstruction loss between the input training voices and the synthesized voices, and trains the voice analysis module 103 and the voice synthesis module 104 on the calculated reconstruction loss and the training voices. The processor 101 of the voice synthesis apparatus 10 calculates the reconstruction loss between the input training voices and the output voices. The processor 101 inputs the calculated reconstruction loss and the training voices to the voice analysis module 103. The voice analysis module 103 and the voice synthesis module 104 are trained based on the input reconstruction loss and training voices. Detailed descriptions of the reconstruction loss calculation and learning method of the voice synthesis apparatus 10 in step 903 will be replaced with the descriptions given in conjunction with step 803.

In step 904, the voice synthesis apparatus 10 obtains a singing voice synthesis request including a synthesis target song and a synthesis target singer (a reference singer). The input module 102 of the voice synthesis apparatus 10 receives a synthesis target song, which the user wants to hear, and a synthesis target singer from a user. The input module 102 inputs the synthesis target song and the synthesis target singer to the SVS module 105. In this case, the synthesis target song includes a musical score and lyrics for the song that the user wants to synthesize. Data representing the musical score and lyrics for the synthesis target song may be data stored in the storage 109 of the voice synthesis apparatus 10, or may be data input by the user.

In step 905, the voice synthesis apparatus 10 obtains a voice signal associated with the synthesis target singer based on the singing voice synthesis request. The voice synthesis apparatus 10 obtains a voice signal associated with the synthesis target singer included in the singing voice synthesis request. For example, the processor 101 of the voice synthesis apparatus 10 searches for the voice associated with the synthesis target singer from the storage 109 and obtains a voice signal, representing the voice associated with the synthesis target singer, from the storage 109. According to another embodiment, the input module 102 of the voice synthesis apparatus 10 may obtain the voice associated with a synthesis target singer from the user. The voice associated with the synthesis target singer is the voice in which a song sung by the synthesis target singer is recorded. The voice synthesis apparatus 10 inputs the obtained voice signal associated with the synthesis target singer to the voice analysis module 103 and the SVS module 105.

In step 906, the voice synthesis apparatus 10 generates and outputs singing voice features including a fundamental frequency F₀, a periodic amplitude Aₚ[n], an aperiodic amplitude Aₐₚ[n], and linguistic features based on the singing voice synthesis request and the voice associated with the synthesis target singer. More specifically, the SVS module 105 of the voice synthesis apparatus 10 generates and outputs singing voice features for a singing voice based on the input synthesis target song and the voice associated with the synthesis target singer. The singing voice features include a fundamental frequency F₀, a periodic amplitude Aₚ[n], an aperiodic amplitude Aₐₚ[n], and linguistic features for the singing voice. The SVS module 105 generates and outputs a fundamental frequency F₀, a periodic amplitude Aₚ[n], an aperiodic amplitude Aₐₚ[n], and linguistic features for the singing voice, in which the target song is sung using the voice of the synthesis target singer, based on the input musical score and text of the synthesis target song and the voice of the synthesis target singer.

In this case, the SVS module 105 is an artificial neural network that is pre-trained on a training dataset. The SVS module 105 is an artificial neural network that is pre-trained to output singing voice features for an input song and singer when the song and the singer are input by using an SVS training dataset including training songs, training singers, and training singing voice features. The SVS module 105 is an artificial neural network that is trained using a supervised learning method.

In step 907, the voice synthesis apparatus 10 generates the timbre features of the synthesis target singer based on a voice signal associated with the synthesis target singer. The voice analysis module 103 of the voice synthesis apparatus 10 analyzes a voice associated with the synthesis target singer, and generates the timbre features of the synthesis target singer. The voice analysis module 103 is an artificial neural network that is trained through self-supervised learning in step 901. The voice analysis module 103 analyzes the voice associated with the input synthesis target singer, and outputs the fundamental frequency F₀, periodic amplitude Aₚ[n], aperiodic amplitude Aₐₚ[n], linguistic features, and timbre features of the voice associated with the synthesis target singer. In this case, the voice analysis module 103 inputs only the timbre features of the synthesis target singer to the voice synthesis module 104.

In step 908, the voice synthesis apparatus 10 synthesizes a singing voice signal representing the voice, in which the synthesis target song is sung using the voice of the target singer, based on the singing voice features and the timbre features of the target singer. The voice synthesis module 104 of the voice synthesis apparatus 10 synthesizes a singing voice based on a fundamental frequency F₀, a periodic amplitude Aₚ[n], and an aperiodic amplitude Aₐₚ[n], and linguistic features for the singing voice, in which the target song is sung using the voice of the target singer, input from the SVS module 105 and the timbre features of the voice associated with the synthesis target singer input from the voice analysis module 103. The voice synthesis module 104 is an artificial neural network that is trained through self-supervised learning in step 902. The voice synthesis module 104 inputs the synthesized singing voice signal to the output module 108.

In step 909, the output module 108 of the voice synthesis apparatus 10 outputs a singing voice signal. The output module 108 converts the singing voice signal into sound waves and outputs them.

The self-supervised learning-based singing voice synthesis method shown in FIG. 9 may use the voice analysis module 103 and the voice synthesis module 104 that are pre-trained by a self-learning method. In this case, steps 901, 902, and 903 may be omitted.

The singing voice synthesis method according to the above-described embodiment of the present disclosure may synthesize the voice in which a song desired by the user is sung using the voice of a singer desired by the user in the above-described manner.

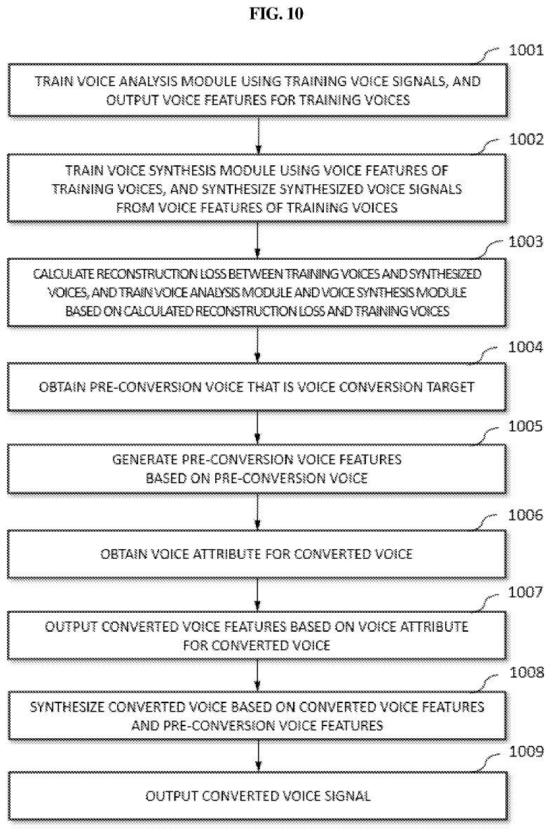

FIG. 10 is a flowchart of a self-supervised learning-based modified voice synthesis method according to another embodiment of the present disclosure. It is assumed that, among the artificial neural networks of the voice synthesis apparatus 10 that performs the self-supervised learning-based modified voice synthesis method shown in FIG. 10, the SVS module 105, the VOD module 106, and the TTS module 107, which are supervised learning models, are each trained in advance on a training dataset before performing the modified voice synthesis method according to the present embodiment of the present disclosure.

Referring to FIG. 10, in step 1001, the voice synthesis apparatus 10 trains the voice analysis module 103 of the voice synthesis apparatus 10 to output voice features for training voices by using training voice signals representing the training voices, and outputs the voice features for the training voices. The voice synthesis apparatus 10 trains the voice analysis module 103 through self-supervised learning. Detailed descriptions of the operation and learning method of the voice analysis module 103 in step 1001 will be replaced with the descriptions given in conjunction with step 801.

In step 1002, the voice synthesis apparatus 10 trains the voice synthesis module 104 to synthesize voice signals from the voice features of the training voices by using the voice features of the training voices, and synthesizes synthesized voice signals from the voice features of the training voices. The voice synthesis apparatus 10 trains the voice synthesis module 104 through self-supervised learning. Detailed descriptions of the operation and learning method of the voice synthesis module 104 in step 1002 will be replaced with the descriptions given in conjunction with step 802.

In step 1003, the voice synthesis apparatus 10 calculates the reconstruction loss between the input training voices and the synthesized voices, and trains the voice analysis module 103 and the voice synthesis module 104 on the calculated reconstruction loss and the training voices. The processor 101 of the voice synthesis apparatus 10 calculates the reconstruction loss between the input training voices and the output voices. The processor 101 inputs the calculated reconstruction loss and the training voices to the voice analysis module 103. The voice analysis module 103 and the voice synthesis module 104 are trained based on the input reconstruction loss and the training voices. Detailed descriptions of the reconstruction loss calculation and learning method of the voice synthesis apparatus 10 in step 1003 will be replaced with the descriptions given in conjunction with step 803.

In step 1004, the voice synthesis apparatus 10 obtains a pre-conversion voice that is a voice conversion target. The input module 102 of the voice synthesis apparatus 10 obtains a pre-conversion voice that is a voice conversion target from the user. The voice synthesis apparatus 10 may directly receive a pre-conversion voice from the user through the input module 102. Alternatively, the voice synthesis apparatus 10 may receive a command for a pre-conversion voice that is a target of voice conversion from the user through the input module 102, and may search for and obtain the pre-conversion voice from the storage 109. The input module 102 inputs the obtained pre-conversion voice to the voice analysis module 103.

In step 1005, the voice synthesis apparatus 10 generates and outputs pre-conversion voice features representing the features of the pre-conversion voice based on the obtained pre-conversion voice. More specifically, the voice analysis module 103 of the voice synthesis apparatus 10 generates and outputs the voice features of the pre-conversion voice from the pre-conversion voice. The voice analysis module 103 trained in step 1001 analyzes the input pre-conversion voice, and outputs the fundamental frequency F₀, periodic amplitude Aₚ[n], aperiodic amplitude Aₐₚ[n], linguistic features, and timbre features of the pre-conversion voice. The voice analysis module 103 inputs the periodic amplitude Aₚ[n], the aperiodic amplitude Aa [n] and the linguistic features, selected from the output voice features of the pre-conversion voice, to the voice synthesis module 104.

In step 1006, the voice synthesis apparatus 10 obtains a voice attribute for the converted voice. The input module 102 of the voice synthesis apparatus 10 receives a voice attribute for the converted voice that the user wants to convert from the user. The input module 102 inputs the input voice attribute to the VOD module 106. In this case, the voice attribute for the converted voice is the conversion target attribute of the voice selected from the fundamental features of the voice, and include the age, gender, and/or pitch of a voice subject (a speaker). The user inputs the conversion target voice attribute. For example, when the user wants to convert the current voice subject of the voice from male to female, he or she inputs a command to convert a voice attribute from male to female. The input module 102 inputs the voice attribute for the converted voice to the VOD module 106.

In step 1007, the VOD module 106 of the voice synthesis apparatus 10 outputs converted voice features based on the input voice attribute for the converted voice. The converted voice features include the fundamental frequency F₀ and timbre features of the converted voice. The VOD module 106 generates and outputs a fundamental frequency F₀ and timbre features for the converted voice that the user wants based on the input voice attribute for the converted voice.

The VOD module 106 is an artificial neural network that is pre-trained on a training dataset. The VOD module 106 is an artificial neural network that is pre-trained to, when a voice attribute for the converted voice is input, output a fundamental frequency F₀ and timbre features for the converted voice based on the input voice attribute by using a VOD training dataset including training voices, training voice attributes, training fundamental frequencies F₀, and training timbre features. The VOD module 106 is an artificial neural network that is trained using a supervised learning method.

The VOD module 106 inputs the fundamental frequency F₀ and the timbre features for the output converted voice to the voice synthesis module 104.

In step 1008, the voice synthesis apparatus 10 synthesizes a converted voice based on the converted voice features and the pre-conversion voice features. More specifically, the voice synthesis module 104 of the voice synthesis apparatus 10 synthesizes a converted voice signal based on the periodic amplitude Aₚ[n], aperiodic amplitude Aₐₚ[n] and linguistic features of the pre-conversion voice input from the voice analysis module 103, and the fundamental frequency F₀ and timbre features of the converted voice input from the VOD module 106. The voice synthesis module 104 is an artificial neural network that is trained through self-supervised learning in step 1002. The voice synthesis module 104 inputs the converted voice signal representing the synthesized converted voice to the output module 108.

In step 1009, the output module 108 of the voice synthesis apparatus 10 outputs the converted voice signal. The output module 108 converts the converted voice signal into sound waves and outputs them.

The modulated voice synthesis method according to the above-described embodiment of the present disclosure may convert a voice to have the voice features desired by a user in the above-described manner.

The self-supervised learning-based modulated voice synthesis method shown in FIG. 10 may use the voice analysis module 103 and the voice synthesis module 104 that are pre-trained by a self-learning method. In this case, steps 1001, 1002, and 1003 may be omitted.

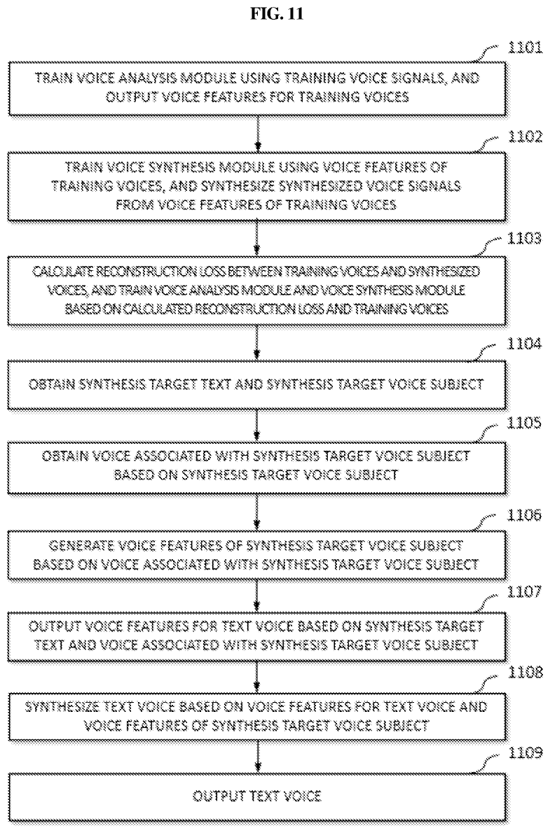

FIG. 11 is a flowchart of a self-supervised learning-based TTS synthesis method according to still another embodiment of the present disclosure. It is assumed that, among the artificial neural networks of the voice synthesis apparatus 10 that performs the self-supervised learning-based TTS synthesis method shown in FIG. 11, the SVS module 105, the VOD module 106, and the TTS module 107, which are supervised learning models, are each trained in advance on a training dataset before performing the TTS synthesis method according to the present embodiment of the present disclosure.

Referring to FIG. 11, in step 1101, the voice synthesis apparatus 10 trains the voice analysis module 103 of the voice synthesis apparatus 10 to output voice features for training voices by using training voice signals representing the training voices, and outputs the voice features of the training voices. The voice synthesis apparatus 10 trains the voice analysis module 103 through self-supervised learning. Detailed descriptions of the operation and learning method of the voice analysis module 103 in step 1101 will be replaced with the descriptions given in conjunction with step 801.

In step 1102, the voice synthesis apparatus 10 trains the voice synthesis module 104 to synthesize voice signals from the voice features of the training voices by using the voice features of the training voices, and synthesizes synthesized voice signals from the voice features of the training voices. The voice synthesis apparatus 10 trains the voice synthesis module 104 through self-supervised learning. Detailed descriptions of the operation and learning method of the voice synthesis module 104 in step 1102 will be replaced with the descriptions given in conjunction with step 802.

In step 1103, the voice synthesis apparatus 10 calculates the reconstruction loss between the input training voices and the synthesized voices, and trains the voice analysis module 103 and the voice synthesis module 104 on the calculated reconstruction loss and the training voices. The processor 101 of the voice synthesis apparatus 10 calculates the reconstruction loss between the input training voices and the output voices. The processor 101 inputs the calculated reconstruction loss and the training voices to the voice analysis module 103. The voice analysis module 103 and the voice synthesis module 104 are trained on the input reconstruction loss and training voices. Detailed descriptions of the reconstruction loss calculation and learning method of the voice synthesis apparatus 10 in step 1103 will be replaced with the descriptions given in conjunction with step 803.

In step 1104, the voice synthesis apparatus 10 obtains a synthesis target text, for which TTS synthesis is desired, and a synthesis target voice subject. The input module 102 of the voice synthesis apparatus 10 obtains a synthesis target text, which is a target of TTS synthesis, and a synthesis target voice subject from a user. The synthesis target text refers to a text for which TTS synthesis is desired, and the synthesis target voice subject refers to the subject of the voice in which the synthesis target text is read. The input module 102 inputs the obtained synthesis target text into the TTS module 107 and inputs the synthesis target voice subject into the processor 101.

In step 1105, the voice synthesis apparatus 10 obtains a voice associated with the synthesis target voice subject based on the synthesis target voice subject. More specifically, the processor 101 of the voice synthesis apparatus 10 searches for and obtains a voice associated with the synthesis target voice subject from the storage 109. The processor 101 inputs the voice associated with the synthesis target voice subject to the voice analysis module 103 and the TTS module 107.

In step 1106, the voice synthesis apparatus 10 generates and outputs the voice features of the synthesis target voice subject based on the voice associated with the synthesis target voice subject. The voice analysis module 103 of the voice synthesis apparatus 10 generates and outputs the voice features of the synthesis target voice subject from the voice associated with the synthesis target voice subject. The voice analysis module 103 trained in step 1101 analyzes the voice associated with the input synthesis target voice subject, and outputs the fundamental frequency F₀, periodic amplitude Aₚ[n], aperiodic amplitude Aₐₚ[n], linguistic features, and timbre features of the voice associated with the synthesis target voice subject. The voice analysis module 103 inputs the timbre features, selected from the output voice features associated with the synthesis target voice subject, to the voice synthesis module 104.

In step 1107, the voice synthesis apparatus 10 outputs voice features for the text voice, in which the synthesis target text is read using the voice of the synthesis target voice subject, based on the synthesis target text and the voice associated with the synthesis target voice subject. In this case, the text voice refers to the voice in which the synthesis target text is read using the voice of the synthesis target voice subject. The voice features for text voice include a fundamental frequency F₀, periodic amplitude Aₚ[n], and aperiodic amplitude Aₐₚ[n] for the text voice. The TTS module 107 of the voice synthesis apparatus 10 generates and outputs a fundamental frequency F₀, periodic amplitude Aₚ[n], and aperiodic amplitude Aₐₚ[n] for the text voice that a user wants to synthesize based on the input synthesis target text and the voice associated with the synthesis target voice subject.

The TTS module 107 is an artificial neural network that is pre-trained on a training dataset. The TTS module 107 is an artificial neural network that is pre-trained to, when a synthesized text and a voice associated with a synthesis target voice subject are input, output a fundamental frequency F₀, periodic amplitude Aₚ[n], and aperiodic amplitude Aₐₚ[n] for a text voice, which is the voice in which the input synthesized text is read using the voice of the synthesis target voice subject, by using a TTS training dataset including training synthesized texts, training voices, and training voice features.

TTS module 107 inputs the output fundamental frequency F₀, periodic amplitude Aₚ[n], and aperiodic amplitude Aₐₚ[n] for the text voice to the voice synthesis module 104.

In step 1108, the voice synthesis apparatus 10 synthesizes the text voice based on the voice features for the text voice and the voice features of the synthesis target voice subject. More specifically, the voice synthesis module 104 of the voice synthesis apparatus 10 synthesizes a text voice signal representing the text voice based on the fundamental frequency F₀, the periodic amplitude Aₚ[n], and the aperiodic amplitude Aₐₚ[n] for the text voice input from the TTS module 107 and the timbre features input from the voice analysis module 103. The voice synthesis module 104 is an artificial neural network that is trained through self-supervised learning in step 1102. The voice synthesis module 104 inputs the synthesized text voice signal to the output module 108.

In step 1109, the output module 108 of the voice synthesis apparatus 10 outputs the text voice signal. The output module 108 converts the text voice signal into sound waves and outputs them.

The text voice synthesis method according to the above-described embodiment of the present disclosure may synthesize the voice in which the text, for which the user desires voice synthesis, is read using the voice of a desired voice subject (a speaker) in the above-described manner.

The self-supervised learning-based TTS synthesis method shown in FIG. 11 may use the voice analysis module 103 and the voice synthesis module 104 that are pre-trained by a self-learning method. In this case, steps 1101, 1102, and 1103 may be omitted.

According to the above-described embodiments of the present disclosure, the voice synthesis apparatus and method analyze voice signals using self-supervised learning-based artificial intelligence, extract the voice features of the voice signals, and synthesize voices again based on the extracted voice features. The artificial intelligence outputs the voice features of input voices while repeating the analysis and synthesis of voice signals, and synthesizes voices again based on the output voice features. According to the embodiments of the present disclosure, the artificial neural networks are trained to extract the voice features of input voices by themselves, and are also trained to output synthesized voices based on the extracted voice features. The self-supervised learning-based artificial intelligence model is employed, so that there is no need for a large amount of training audio data required to train an artificial neural network model compared to a supervised learning-based artificial intelligence model in the field of voice synthesis, and so that the artificial neural networks for voice synthesis can be trained rapidly and easily.

Furthermore, according to the embodiments of the present disclosure, the voice analysis module and the voice synthesis module, which are artificial neural networks of the voice synthesis apparatus, calculate the reconstruction loss between input voices and synthesized voices during self-supervised learning and are trained based on the calculated reconstruction loss, so that the differences between the voices synthesized by the voice synthesis apparatus and actual voices are minimized. Accordingly, the voice synthesis apparatus may synthesize voices, which are more natural and considerably similar to actual voices, by using a loss function.

The voice synthesis method according to the embodiment of the present disclosure may convert an arbitrary singing voice into the voice of a singer desired by a user by utilizing the artificial neural networks that are trained by a self-supervised learning method. Accordingly, it may be possible to synthesize a singing voice that is not actually sung by a synthesis target singer but is identical or considerably similar and natural as if it were actually sung by the synthesis target singer.

Furthermore, the voice synthesis method according to the embodiment of the present disclosure may train the artificial neural networks capable of analyzing voices using only a predetermined quantity of training voices and synthesizing voices based on the results of the analysis. For example, the artificial neural networks for voice synthesis may be trained using a small quantity of voices corresponding to about 10 minutes. Accordingly, the voice of the deceased may be restored using only a small quantity of data in which the voice of a singer or great person who passed away was recorded while he or she was alive without a large quantity of voice data or voice data over a long period of time.

Furthermore, the voice synthesis method according to the embodiment of the present disclosure to convert a voice recorded as the voice of an arbitrary voice subject into a voice with different voice characteristics by utilizing the artificial neural networks that are trained by a self-supervised learning method. For example, a voice may be freely modulated into a voice having voice features desired by a user, as in the cases where a male voice is modulated into a female voice, a young person's voice can be modulated into an old person's voice, etc.

Moreover, the voice synthesis method according to the embodiment of the present disclosure may synthesize the voice in which an arbitrary text is recorded using the voice of an arbitrary voice subject by utilizing the artificial neural networks that are trained by a self-supervised learning method. In this case, a text voice is synthesized using the artificial neural networks that are trained by a self-supervised learning method, so that it may be possible to synthesize a voice that is considerably natural as if a voice directly read by a voice subject input by a user were recorded.

Meanwhile, the above-described embodiments of the present disclosure may be written as programs that can be executed on a computer, and may be implemented in a general-purpose digital computer that executes the programs using a computer-readable storage medium. Furthermore, the data structures used in the above-described embodiments of the present disclosure may be recorded on a computer-readable storage medium through various means. The computer-readable storage medium includes storage media such as magnetic storage media (e.g., ROM, floppy disks, hard disks, etc.) and optical readable media (e.g., CD-ROM, DVD, etc.). Programs for performing the singing voice synthesis methods according to the embodiments of the present disclosure are recorded on the computer-readable storage medium.

So far, the present disclosure has been described with a focus on preferred embodiments. Those of ordinary skill in the art to which the present disclosure pertains will understand that the present disclosure may be implemented in modified forms without departing from the essential characteristics of the present disclosure. Therefore, the disclosed embodiments should be taken into consideration from an illustrative perspective rather than a restrictive perspective. The scope of the present disclosure is defined in the claims rather than the foregoing description, and all differences falling within a range equivalent to the claims should be construed as being included in the present disclosure.

What is claimed is:

1. A self-supervised learning-based voice synthesis method comprising:
training a voice analysis module to output voice features for training voice signals by using the training voice signals representing training voices, and outputting voice features for the training voices; and
training a voice synthesis module to synthesize voice signals from the voice features for the training voices by using the output voice features, and synthesizing synthesized voice signals, representing synthesized voices, from the output voice features.

2. The self-supervised learning-based voice synthesis method of claim 1, further comprising calculating reconstruction loss between the training voice signals and the synthesized voice signals based on the training voice signals and the synthesized voice signals, and training the voice analysis module and the voice synthesis module based on the calculated reconstruction loss.

3. The self-supervised learning-based voice synthesis method of claim 1, wherein:
voice features of each of the training voices include a fundamental frequency F₀, periodic amplitude Aₚ[n], aperiodic amplitude Aₐₚ[n], linguistic features, and timbre features of the training voice; and
outputting the voice features of the training voices includes:
converting each of the training voice signals into probability distribution spectra of a plurality of frequency bins, and outputting a fundamental frequency F₀, periodic amplitude Aₚ[n], and aperiodic amplitude Aₐₚ[n] of the training voice from the probability distribution spectra obtained through the conversion;
outputting linguistic features of a text included in the training voice from the training voice signal; and
converting the training voice signal into a mel-spectrogram, and outputting timbre features of the training voice from the mel-spectrogram obtained through the conversion.

4. The self-supervised learning-based voice synthesis method of claim 3, wherein synthesizing synthetic voice signals, representing synthetic voices, from the output voice features includes:
generating an input excitation signal based on the fundamental frequency F₀, periodic amplitude Aₚ[n], and aperiodic amplitude Aₐₚ[n] of the training voice;
generating a time-varying timbre embedding based on the timbre features of the training voice;
generating frame-level conditions for the synthesized voice based on the linguistic features of the training voice and the generated time-varying timbre embedding; and
synthesizing a synthesized voice signal representing the synthesized voice based on the input excitation signal and the frame-level conditions.

5. The self-supervised learning-based voice synthesis method of claim 4, wherein the input excitation signal is represented by Equation 1 below:
$$z [ t ] = {A}_{p} [ t ] sin ( {\sum }_{k = 1}^{t} 2 π \frac{{F}_{0} [ k ]}{{N}_{s}} ) + {A}_{ap} [ t ] \cdot n [ t ] ,$$
wherein Nₛ is sampling rate, and n[t] is sampled noise.

6. A self-supervised learning-based singing voice synthesis method, the self-supervised learning-based singing voice synthesis method being performed by a voice synthesis apparatus, including a voice analysis module configured to be trained to output voice features for training voice signals by using the training voice signals representing training voices, and to output voice features for the training voices, and a voice synthesis module configured to train to synthesize voice signals from the voice features for the training voices by using the output voice features, and to synthesize synthesized voice signals, representing synthesized voices, from the output voice features, the self-supervised learning-based singing voice synthesis method comprising:
obtaining a singing voice synthesis request including a synthesis target song and a synthesis target singer;
obtaining a voice signal associated with the synthesis target singer based on the singing voice synthesis request;
generating, in a singing voice synthesis (SVS) module, singing voice features including a fundamental frequency F₀, periodic amplitude Aₚ[n], aperiodic amplitude Aₐₚ[n], and linguistic features for the synthesis target song and the synthesis target singer based on the singing voice synthesis request and the voice signal associated with the synthesis target singer;
generating, in the voice analysis module, timbre features of the synthesis target singer based on the voice signal associated with the synthesis target singer; and
synthesizing, in the voice synthesis module, a singing voice signal, representing a voice in which the synthesis target song is sung using a voice of the synthesis target singer, based on the singing voice features and the timbre features.

7. The self-supervised learning-based singing voice synthesis method of claim 6, wherein the SVS module is an artificial neural network that is pre-trained to output singing voice features for an input synthesis target song and synthesis target singer by using a training dataset including training songs, training singer voices, and training singing voice features.

8. A self-supervised learning-based modified voice synthesis method, the self-supervised learning-based modified voice synthesis method being performed by a voice synthesis apparatus, including a voice analysis module configured to be trained to output voice features for training voice signals by using the training voice signals representing training voices, and to output voice features for the training voices, and a voice synthesis module configured to train to synthesize voice signals from the voice features for the training voices by using the output voice features, and to synthesize synthesized voice signals, representing synthesized voices, from the output voice features, the self-supervised learning-based modified voice synthesis method comprising:
obtaining a pre-conversion voice that is a voice conversion target;
outputting, in the voice analysis module, pre-conversion voice features including a fundamental frequency F₀, periodic amplitude Aₚ[n], aperiodic amplitude Aw [n], and linguistic features for the pre-conversion voice based on the obtained pre-conversion voice;
obtaining voice attributes for a converted voice;
outputting, in a voice design (VOD) module, converted voice features including a fundamental frequency F₀ and timbre features for the converted voice based on the voice attributes for the converted voice; and
synthesizing, in the voice synthesis module, the converted voice based on the pre-conversion voice features and the converted voice features.

9. The self-supervised learning-based modified voice synthesis method of claim 8, wherein the VOD module is an artificial neural network that is pre-trained to output a fundamental frequency F₀ and timbre features of the converted voice based on input voice attributes by using a training dataset including training voice attributes, training basic frequencies F₀, and training timbre features.

10. A self-supervised learning-based text to speech (TTS) synthesis method, the self-supervised learning-based TTS synthesis method being performed by a voice synthesis apparatus, including a voice analysis module configured to be trained to output voice features for training voice signals by using the training voice signals representing training voices, and to output voice features for the training voices, and a voice synthesis module configured to train to synthesize voice signals from the voice features for the training voices by using the output voice features, and to synthesize synthesized voice signals, representing synthesized voices, from the output voice features, the self-supervised learning-based TTS synthesis method comprising:
obtaining a synthesis target text and a synthesis target voice subject for which TTS synthesis is desired;
obtaining a voice associated with the synthesis target voice subject based on the synthesis target voice subject;
outputting, in the voice analysis module, voice features of the synthesis target voice subject, including timbre features of the synthesis target voice subject, based on the voice associated with the synthesis target voice subject;
outputting, in a TTS module, voice features of a text voice, including a fundamental frequency F₀, periodic amplitude Aₚ[n], and aperiodic amplitude Aₐₚ[n] for the text voice in which the synthesis target text is read using a voice of the synthesis target voice subject, based on the synthesis target text and the voice associated with the synthesis target voice subject; and
synthesizing the text voice based on the fundamental frequency F₀, periodic amplitude Aₚ[n], and aperiodic amplitude Aₐₚ[n] for the text voice and the timbre features of the synthesis target voice subject.

11. The self-supervised learning-based TTS synthesis method of claim 10, wherein the TTS module is an artificial neural network that is pre-trained to output the fundamental frequency F₀, periodic amplitude Aₚ[n], and aperiodic amplitude Aₐₚ[n] of the text voice based on an input text and voice by using a training dataset including training synthesized texts, training voices, and training voice features.
